(19) United States
(12) Patent Application Publication
(10) Pub. No.: US 2024/0118839 A1
(43) Pub. Date: Apr. 11, 2024

(54) MEMORY SYSTEM AND OPERATING METHOD OF MEMORY SYSTEM

(71) Applicant: SK hynix Inc., Gyeonggi-do (KR)

(72) Inventors: Jeong Hyun KIM, Gyeonggi-do (KR); Ji Hun CHOI, Gyeonggi-do (KR)

(21) Appl. No.: 17/962,832

(22) Filed: Oct. 10, 2022

(30) Foreign Application Priority Data
Apr. 4, 2022 (KR) 10-2022-0041860

(51) Int. Cl. G06F 11/14; G06F 11/07

(52) U.S. Cl. CPC G06F 11/1469; G06F 11/0772; G06F 11/1451

(57) ABSTRACT

According to embodiments of the present disclosure, there may be provided a memory system and an operating method thereof, including a host accessible area accessible directly from an external device, transmitting information on the host accessible area to an external memory, receiving a direct memory access request generated based on the information for the host accessible area from the external device according to an urgent event, and providing the external device with a direct memory access to the host accessible area in response to the direct memory access request.

The present application claims priority under 35 U.S.C. § 119(a) to Korean Patent Application No. 10-2022-0041860 filed on Apr. 4, 2022, which is incorporated herein by reference in its entirety.

### BACKGROUND

### 1. Technical Field

The present disclosure relates to a memory system and an operating method thereof.

### 2. Related Art

A memory system includes a data storage device that stores data on the basis of a request from a host, such as a computer, servers, a smartphone, a tablet PC, or other electronic devices. The examples of the memory system span from a traditional magnetic-disk-based hard disk drive (HDD) to a semiconductor-based data storage device such as a solid state drive (SSD), a universal flash storage (UFS) device, or an embedded MMC (eMMC) device.

The memory system may further include a memory controller for controlling a memory device. The memory controller may receive a command from the host and, on the basis of the received command, may execute the command or control read/write/erase operations on the memory devices in the memory system. The memory controller may be used to execute firmware operations for performing a logical operation for controlling such operations.

The memory controller is capable of writing by transmitting data to an external memory or reading the data from the external memory.

### SUMMARY

According to embodiments of the present disclosure, there may be provided a memory system and an operating method thereof that provide a direct memory access when the memory system is accessed based on data stored in an external memory according to an urgent event from outside the memory system.

According to embodiments of the present disclosure, there may be provided the memory system, including a memory device including a host accessible area accessible by an external device and a memory controller suitable for transmitting, to an external memory, information on the host accessible area, receiving, from the external device in response to an urgent event, a direct memory access request generated based on the information on the host accessible area, and providing, in response to the direct memory access request, the direct memory access to the external device.

According to embodiments of the present disclosure, there may be provided the operating method of the memory system, including transmitting, to an external memory, the information for the host accessible area that can be accessed by the external device, receiving, from the external device in response to an urgent event, the direct memory access request generated based on the information on the host accessible area, and providing, in response to the direct memory access request, the direct memory access to the external device.

According to embodiments of the present disclosure, there may be provided the memory system and the operating method thereof that provide the direct memory access to the external device that directly accesses the memory system based on the information stored in the external memory according to the urgent event.

### BRIEF DESCRIPTION OF THE DRAWINGS

FIG. 1 is a schematic diagram illustrating the feature of a memory system according to embodiments of the present disclosure.

FIG. 2 is a block diagram schematically illustrating a memory device according to embodiments of the present disclosure.

FIG. 3 is a diagram illustrating a structure of word lines and bit lines of the memory device according to embodiments of the present disclosure.

FIG. 4 is a diagram illustrating an external device and the memory system according to embodiments of the present disclosure.

FIG. 5 is a diagram illustrating a memory access of the external device by layer according to embodiments of the present disclosure.

FIG. 6 is a diagram illustrating a direct memory access request according to embodiments of the present disclosure.

FIG. 7 is a diagram illustrating an operation of a memory controller in response to an urgent event according to embodiments of the present disclosure.

FIG. 8 is a diagram illustrating the operation of the memory controller during a sudden power-off according to embodiments of the present disclosure.

FIG. 9 is a diagram illustrating the operation of the memory controller during a power-on recovery according to embodiments of the present disclosure.

FIG. 10 is a diagram illustrating the operation of the memory controller for each temperature according to embodiments of the present disclosure.

FIG. 11 is a diagram illustrating an operating method of the memory system according to embodiments of the present disclosure.

FIG. 12 is a diagram illustrating the feature of a computing system according to embodiments of the present disclosure.

### DETAILED DESCRIPTION

Hereinafter, embodiments of the present disclosure are described in detail with reference to the accompanying drawings. Throughout the specification, reference to “an embodiment,” “another embodiment” or the like is not necessarily to only one embodiment, and different references to any such phrase are not necessarily to the same embodiment(s). The term “embodiments” when used herein does not necessarily refer to all embodiments.

Various embodiments of the present invention are described below in more detail with reference to the accompanying drawings. We note, however, that the present invention may be embodied in different forms and variations, and should not be construed as being limited to the embodiments set forth herein. Rather, the described embodiments are provided so that this disclosure will be thorough and complete, and will fully convey the present invention to those skilled in the art to which this invention pertains. Throughout this disclosure, like reference numerals refer to like parts throughout the various figures and embodiments of the present invention.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented at least partially in software, the controllers, processors, devices, modules, units, multiplexers, generators, logic, interfaces, decoders, drivers, generators and other signal generating and signal processing features may include, for example, a memory or other storage device for storing code or instructions to be executed, for example, by a computer, processor, microprocessor, controller, or other signal processing device.

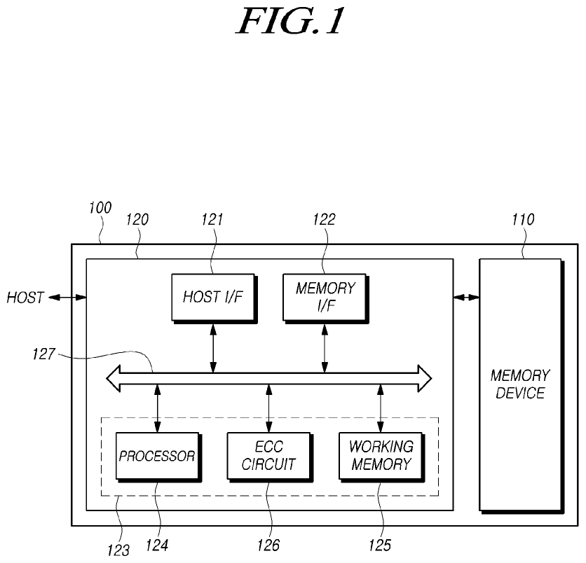

FIG. 1 is a diagram illustrating the schematic configuration of a memory system 100 based on an embodiment of the present disclosure.

In some implementations, the memory system 100 may include a memory device 110 configured to store data, and a memory controller 120 configured to control the memory device 110.

The memory device 110 may include multiple memory blocks each including a plurality of memory cells for storing data. The memory device 110 may be configured to operate in response to control signals received from the memory controller 120. Operations of the memory device 110 may include, for example, a read operation, a program operation (also referred to as a “write operation”), an erasure operation, and the like.

The memory cells in the memory device 110 are used to store data and may be arranged in a memory cell array. The memory cell array may be divided into memory blocks of memory cells and each block includes different pages of memory cells. In typical implementations of NAND flash memory devices, a page of memory cells is the smallest memory unit that can be programmed or written, and the data stored in memory cells can be erased at the block level.

In some implementations, the memory device 110 may be implemented as various types, such as a double data rate synchronous dynamic random access memory (DDR SDRAM), a low power double data rate4 (LPDDR4) SDRAM, a graphics double data rate (GDDR) SDRAM, a low power DDR (LPDDR), a Rambus dynamic random access memory (RDRAM), a NAND flash memory, a vertical NAND flash memory, a NOR flash memory, a resistive random access memory (RRAM), a phase-change random access memory (PRAM), a magneto resistive random access memory (MRAM), a ferroelectric random access memory (FRAM), or a spin transfer torque random access memory (STT-RAM).

The memory device 110 may be implemented in a three-dimensional array structure. Some embodiments of the disclosed technology are applicable to any type of flash memory devices having an electric charge storage layer. In an implementation, the electric charge storage layer may be formed of a conductive material, and such an electric charge storage layer can be called a floating gate. In another implementation, the electric charge storage layer may be formed of an insulating material, and such a flash memory device can be called a charge trap flash (CTF).

The memory device 110 may be configured to receive a command and an address from the memory controller 120 to access an area of the memory cell array selected using the address. That is, the memory device 110 may perform an operation corresponding to the received command on a memory area of the memory device having a physical address corresponding to the received address from the memory controller 120.

In some implementations, the memory device 110 may perform a program operation, a read operation, an erasure operation, and the like. During the program operation, the memory device 110 may write data in the area selected by the address. During the read operation, the memory device 110 may read data from a memory area selected by the address. During the erasure operation, the memory device 110 may erase data stored in a memory area selected by the address.

The memory controller 120 may control write (program), read, erasure, and background operations that are performed on the memory device 110. The background operation may include, for example, operations that are implemented to optimize the overall performance of the memory device 110, such as a garbage collection (GC) operation, a wear leveling (WL) operation, and a bad block management (BBM) operation.

The memory controller 120 may control the operation of the memory device 110 at the request of a host. Alternatively, the memory controller 120 may control the operation of the memory device 110 even in absence of request from the host when it performs such background operations of the memory device.

The memory controller 120 and the host may be separate devices. In some implementations, the memory controller 120 and the host may be integrated and implemented as a single device. In the following description, the memory controller 120 and the host will be discussed as separate devices as an example.

Referring to FIG. 1, the memory controller 120 may include a memory interface 122, a control circuit 123, and a host interface 121.

The host interface 121 may be configured to provide an interface for communication with the host.

When receiving a command from the host HOST, the control circuit 123 may receive the command through the host interface 121 and may perform an operation of processing the received command.

The memory interface 122 may be directly or indirectly connected to the memory device 110 to provide an interface for communication with the memory device 110. That is, the memory interface 122 may be configured to provide the memory device 110 and the memory controller 120 with an interface for the memory controller 120 to perform memory operations on the memory device 110 based on control signals and instructions from the control circuit 123.

The control circuit 123 may be configured to control the operation of the memory device 110 through the memory controller 120. For example, the control circuit 123 may include a processor 124 and a working memory 125. The control circuit 123 may further include an error detection/correction circuit (ECC circuit) 126 and the like.

The processor 124 may control the overall operation of the memory controller 120. The processor 124 may perform a logical operation. The processor 124 may communicate with the host HOST through the host interface 121. The processor 124 may communicate with the memory device 110 through the memory interface 122.

The processor 124 may be used to perform operations associated with a flash translation layer (FTL) to effectively manage the memory operations on the memory system 100. The processor 124 may translate a logical block address (LBA) provided by the host into a physical block address (PBA) through the FTL. The FTL may receive the LBA and translate the LBA into the PBA by using a mapping table.

There are various address mapping methods which may be employed by the FTL, based on the mapping unit. Typical address mapping methods may include a page mapping method, a block mapping method, and a hybrid mapping method.

The processor 124 may be configured to randomize data received from the host to write the randomized data to the memory cell array. For example, the processor 124 may randomize data received from the host by using a randomizing seed. The randomized data is provided to the memory device 110 and written to the memory cell array.

The processor 124 may be configured to derandomize data received from the memory device 110 during a read operation. For example, the processor 124 may derandomize data received from the memory device 110 by using a derandomizing seed. The derandomized data may be output to the host HOST.

The processor 124 may execute firmware (FW) to control the operation of the memory controller 120. The processor 124 may control the overall operation of the memory controller 120 and, in order to perform a logical operation, may execute (drive) firmware loaded into the working memory 125 during booting.

The firmware refers to a program or software stored on a certain nonvolatile memory and is executed inside the memory system 100.

In some implementations, the firmware may include various functional layers. For example, the firmware may include at least one of a flash translation layer (FTL) configured to translate a logical address in the host HOST requests to a physical address of the memory device 110, a host interface layer (HIL) configured to interpret a command that the host HOST issues to a data storage device such as the memory system 100 and to deliver the command to the FTL, and a flash interface layer (FIL) configured to deliver a command issued by the FTL to the memory device 110.

For example, the firmware may be stored in the memory device 110, and then loaded into the working memory 125.

The working memory 125 may store firmware, program codes, commands, or pieces of data necessary to operate the memory controller 120. The working memory 125 may include, for example, at least one among a static RAM (SRAM), a dynamic RAM (DRAM), and a synchronous RAM (SDRAM) as a volatile memory.

The error detection/correction circuit 126 may be configured to detect and correct one or more erroneous bits in the data by using an error detection and correction code. In some implementations, the data that is subject to the error detection and correction may include data stored in the working memory 125, and data retrieved from the memory device 110.

The error detection/correction circuit 126 may be implemented to decode data by using the error correction code. The error detection/correction circuit 126 may be implemented by using various decoding schemes. For example, a decoder that performs nonsystematic code decoding or a decoder that performs systematic code decoding may be used.

In some implementations, the error detection/correction circuit 126 may detect one or more erroneous bits on a sector basis. That is, each piece of read data may include multiple sectors. In the present disclosure, a sector may refer to a data unit that is smaller than the read unit (e.g., page) of a flash memory. Sectors constituting each piece of read data may be mapped based on addresses.

In some implementations, the error detection/correction circuit 126 may calculate a bit error rate (BER) and determine whether the number of erroneous bits in the data is within the error correction capability sector by sector. For example, if the BER is higher than a reference value, the error detection/correction circuit 126 may determine that the erroneous bits in the corresponding sector are uncorrectable and the corresponding sector is marked “fail.” If the BER is lower than or equals to the reference value, the error detection/correction circuit 126 may determine that the corresponding sector is correctable or the corresponding sector can be marked “pass.”

The error detection/correction circuit 126 may perform error detection and correction operations successively on all read data. When a sector included in the read data is correctable, the error detection/correction circuit 126 may move on to the next sector to check whether an error correction operation is needed on the next sector. Upon completion of the error detection and correction operations on all the read data in this manner, the error detection/correction circuit 126 may acquire information as to which sector is deemed uncorrectable in the read data. The error detection/correction circuit 126 may provide such information (e.g., address of uncorrectable bits) to the processor 124.

The memory system 100 may also include a bus 127 to provide a channel between the constituent elements 121, 122, 124, 125, and 126 of the memory controller 120. The bus 127 may include, for example, a control bus for delivering various types of control signals and commands, and a data bus for delivering various types of data.

By way of example, FIG. 1 illustrates the above-mentioned constituent elements 121, 122, 124, 125, and 126 of the memory controller 120. It is noted that some of the constituent elements illustrated in the drawings may be omitted, or some of the above-mentioned constituent elements 121, 122, 124, 125, and 126 of the memory controller 120 may be integrated into a single element. In addition, in some implementations, one or more other constituent elements may be added to the above-mentioned constituent elements of the memory controller 120.

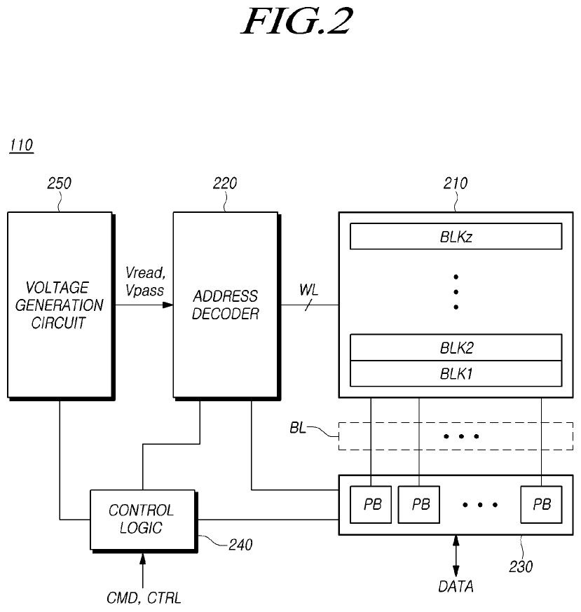

FIG. 2 is a block diagram schematically illustrating a memory device 110 based on an embodiment of the present disclosure.

In some implementations, the memory device 110 based on an embodiment of the disclosed technology may include a memory cell array 210, an address decoder 220, a read/write circuit 230, a control logic 240, and a voltage generation circuit 250.

The memory cell array 210 may include multiple memory blocks BLK1-BLKz, where z is a natural number equal to or greater than 2.

In the multiple memory blocks BLK1-BLKz, multiple word lines WL and multiple bit lines BL may be disposed in rows and columns, and multiple memory cells MC may be arranged.

The multiple memory blocks BLK1-BLKz may be connected to the address decoder 220 through the multiple word lines WL. The multiple memory blocks BLK1-BLKz may be connected to the read/write circuit 230 through the multiple bit lines BL.

Each of the multiple memory blocks BLK1-BLKz may include multiple memory cells. For example, the multiple memory cells are nonvolatile memory cells. In some implementations, such nonvolatile memory cells may be arranged in a vertical channel structure.

The memory cell array 210 may be configured as a memory cell array having a two-dimensional structure. In some implementations, the memory cell array 210 may be arranged in a three-dimensional structure.

Each of the multiple memory cells included in the memory cell array 210 may store at least one bit of data. For example, each of the multiple memory cells included in the memory cell array 210 may be a single-level cell (SLC) configured to store one bit of data. As another example, each of the multiple memory cells included in the memory cell array 210 may be a multi-level cell (MLC) configured to store two bits of data per memory cell. As another example, each of the multiple memory cells included in the memory cell array 210 may be a triple-level cell (TLC) configured to store three bits of data per memory cell. As another example, each of the multiple memory cells included in the memory cell array 210 may be a quad-level cell (QLC) configured to store four bits of data per memory cell. As another example, the memory cell array 210 may include multiple memory cells, each of which may be configured to store at least five bits of data per memory cell.

Referring to FIG. 2, the address decoder 220, the read/write circuit 230, the control logic 240, and the voltage generation circuit 250 may operate as peripheral circuits configured to drive the memory cell array 210.

The address decoder 220 may be connected to the memory cell array 210 through the multiple word lines WL.

The address decoder 220 may be configured to operate in response to command and control signals of the control logic 240.

The address decoder 220 may receive addresses through an input/output buffer inside the memory device 110. The address decoder 220 may be configured to decode a block address among the received addresses. The address decoder 220 may select at least one memory block based on the decoded block address.

The address decoder 220 may receive a read voltage Vread and a pass voltage Vpass from the voltage generation circuit 250.

The address decoder 220 may, during a read operation, apply the read voltage Vread to a selected word line WL inside a selected memory block and apply the pass voltage Vpass to the remaining non-selected word lines WL.

The address decoder 220 may apply a verification voltage generated by the voltage generation circuit 250 to a selected word line WL inside a selected memory block, during a program verification operation, and may apply the pass voltage Vpass to the remaining non-selected word lines WL.

The address decoder 220 may be configured to decode a column address among the received addresses. The address decoder 220 may transmit the decoded column address to the read/write circuit 230.

The memory device 110 may perform the read operation and the program operation page by page. Addresses received when the read operation and the program operation are requested may include at least one of a block address, a row address, and a column address.

The address decoder 220 may select one memory block and one word line based on the block address and the row address. The column address may be decoded by the address decoder 220 and provided to the read/write circuit 230.

The address decoder 220 may include at least one of a block decoder, a row decoder, a column decoder, and an address buffer.

The read/write circuit 230 may include multiple page buffers PB. The read/write circuit 230 may operate as a “read circuit” when the memory cell array 210 performs a read operation, and may operate as a “write circuit” when the memory cell array 210 performs a write operation.

The above-mentioned read/write circuit 230 is also referred to as a page buffer circuit including multiple page buffers PB, or a data register circuit. The read/write circuit 230 may include a data buffer that participates in a data processing function and, in some implementations, may further include a cache buffer for data caching.

The multiple page buffers PB may be connected to the memory cell array 210 through the multiple bit lines BL. In order to detect or sense the threshold voltage Vth of the memory cells during a read operation and a program verification operation, the multiple page buffers PB may continuously supply a sensing current to the bit lines BL connected to the memory cells to detect, at a sensing node, a change proportional to the amount of current that varies depending on the program state of a corresponding memory cell, and may hold or latch the corresponding voltage as sensing data.

The read/write circuit 230 may operate in response to page buffer control signals output from the control logic 240.

During a read operation, the read/write circuit 230 senses a voltage value of a memory cell and the voltage value is read out as data. The read/write circuit 230 temporarily stores the retrieved data, and outputs the data DATA to the input/output buffer of the memory device 110. In an embodiment, the read/write circuit 230 may include a column selection circuit, in addition to the page buffers PB or page registers.

The control logic 240 may be connected to the address decoder 220, the read/write circuit 230, and the voltage generation circuit 250. The control logic 240 may receive a command CMD and a control signal CTRL through the input/output buffer of the memory device 110.

The control logic 240 may be configured to control the overall operation of the memory device 110 in response to the control signal CTRL. The control logic 240 may output a control signal for adjusting the voltage level of sensing nodes of multiple page buffers PB to a pre-charge voltage level.

The control logic 240 may control the read/write circuit 230 to perform a read operation in the memory cell array 210. The voltage generation circuit 250 may generate a read voltage Vread and a pass voltage Vpass, which are used during the read operation, in response to a voltage generation circuit control signal output from the control logic 240.

A memory block BLK included in the memory device 110 may include multiple pages PG. In some implementations, a plurality of memory cells arranged in columns form memory cell strings, and a plurality of memory cells arranged in rows form memory blocks. Each of the multiple pages PG is coupled to one of word lines WL, and each of the memory cell strings STR is coupled to one of bit lines BL.

In the memory block BLK, multiple word lines WL and multiple bit lines BL may be arranged in rows and columns. For example, each of the multiple word lines WL may be arranged in the row direction, and each of the multiple bit lines BL may be arranged in the column direction. As another example, each of the multiple word lines WL may be arranged in the column direction, and each of the multiple bit lines BL may be arranged in the row direction.

In some implementations, the multiple word lines WL and the multiple bit lines BL may intersect with each other, thereby addressing a single memory cell in the array of multiple memory cells MC. In some implementations, each memory cell MC may include a transistor TR that includes a material layer that can hold an electrical charge.

For example, the transistor TR arranged in each memory cell MC may include a drain, a source, and a gate. The drain (or source) of the transistor TR may be connected to the corresponding bit line BL directly or via another transistor TR. The source (or drain) of the transistor TR may be connected to the source line (which may be the ground) directly or via another transistor TR. The gate of the transistor TR may include a floating gate (FG) surrounded by an insulator, and a control gate (CG) to which a gate voltage is applied from a word line WL.

In each of the multiple memory blocks BLK1-BLKz, a first selection line (also referred to as a source selection line or a drain selection line) may be additionally arranged outside the first outermost word line, which is closer to the read/write circuit 230 among two outermost word lines, and a second selection line (also referred to as a drain selection line or a source selection line) may be additionally arranged outside the other second outermost word line.

In some implementations, at least one dummy word line may be additionally arranged between the first outermost word line and the first selection line. In addition, at least one dummy word line may be additionally arranged between the second outermost word line and the second selection line.

A read operation and a program operation (writing operation) of the memory block may be performed page by page, and an erasure operation may be performed memory block by memory block.

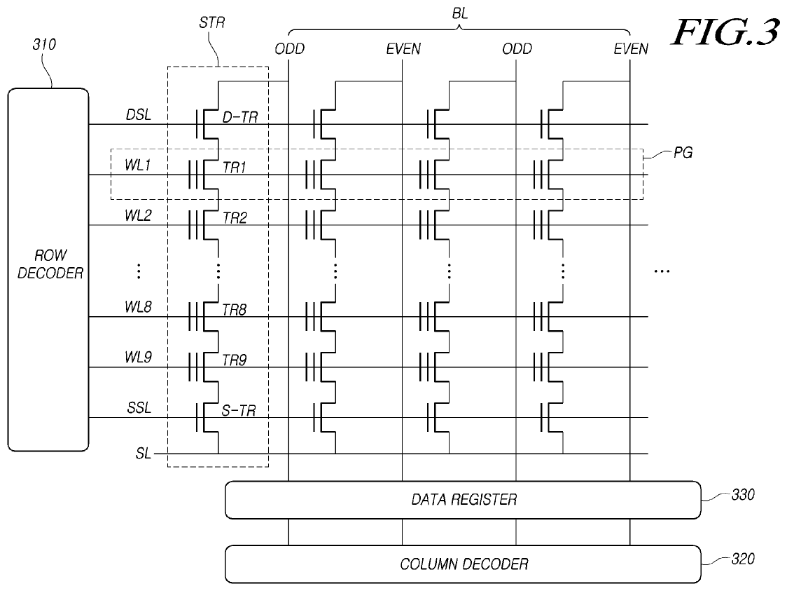

FIG. 3 is a diagram illustrating a structure of word lines WL and bit lines BL of a memory device 110 based on an embodiment of the present disclosure.

Referring to FIG. 3, the memory device 110 has a core area in which memory cells MC are arranged, and an auxiliary area (the remaining area other than the core area) to include circuitry that is used to perform the operations of the memory cell array 210.

In the core area, a certain number of memory cells arranged in one direction can be called “page” PG, and a certain number of memory cells that are coupled in series can be called “memory cell string” STR.

The word lines WL1-WL9 may be connected to a row decoder 310. The bit lines BL may be connected to a column decoder 320. A data register 330, which corresponds to the read/write circuit 230 of FIG. 2, may exist between the multiple bit lines BL and the column decoder 320.

The multiple word lines WL1-WL9 may correspond to multiple pages PG.

For example, each of the multiple word lines WL1-WL9 may correspond to one page PG as illustrated in FIG. 3. When each of the multiple word lines WL1-WL9 has a large size, each of the multiple word lines WL1-WL9 may correspond to at least two (e.g., two or four) pages PG. Each page PG is the smallest unit in a program operation and a read operation, and all memory cells MC within the same page PG may perform simultaneous operations when conducting a program operation and a read operation.

The multiple bit lines BL may be connected to the column decoder 320. In some implementations, the multiple bit lines BL may be divided into odd-numbered bit lines BL and even-numbered bit lines BL such that a pair of an odd-numbered bit line and an even-numbered bit line is coupled in common to a column decoder 320.

In accessing a memory cell MC, the row decoder 310 and the column decoder 320 are used to locate a desired memory cell based on the address.

In some implementations, the data register 330 plays an important role because all data processing by the memory device 110, including program and read operations, occurs via the data register 330. If data processing by the data register 330 is delayed, all of the other areas need to wait until the data register 330 finishes the data processing, degrading the overall performance of the memory device 110.

Referring to the example illustrated in FIG. 3, in one memory cell string STR, multiple transistors TR1-TR9 may be connected to multiple word lines WL1-WL9, respectively. In some implementations, the multiple transistors TR1-TR9 correspond to memory cells MC. In this example, the multiple transistors TR1-TR9 include control gates CG and floating gates FG.

The multiple word lines WL1-WL9 include two outermost word lines WL1 and WL9. A first selection line DSL may be additionally arranged outside the first outermost word line WL1, which is closer to the data register 330 and has a shorter signal path compared to the other outermost word line WL9. A second selection line SSL may be additionally arranged outside the other second outermost word line WL9.

The first selection transistor D-TR, which is controlled to turn on/off by the first selection line DSL, has a gate electrode connected to the first selection line DSL, but includes no floating gate FG. The second selection transistor S-TR, which is controlled to turn on/off by the second selection line SSL, has a gate electrode connected to the second selection line SSL, but includes no floating gate FG.

The first selection transistor D-TR is used as a switch circuit that connects the corresponding memory cell string STR to the data register 330. The second selection transistor S-TR is used as a switch circuit that connects the corresponding memory cell string STR to the source line SL. That is, the first selection transistor D-TR and the second selection transistor S-TR can be used to enable or disable the corresponding memory cell string STR.

In some implementations, the memory system 100 applies a predetermined turn-on voltage Vcc to the gate electrode of the first selection transistor D-TR, thereby turning on the first selection transistor D-TR, and applies a predetermined turn-off voltage (e.g., 0V) to the gate electrode of the second selection transistor S-TR, thereby turning off the second selection transistor S-TR.

The memory system 100 turns on both of the first and second selection transistors D-TR and S-TR during a read operation or a verification operation. Accordingly, during a read operation or a verification operation, an electric current may flow through the corresponding memory cell string STR and drain to the source line SL, which corresponds to the ground, such that the voltage level of the bit line BL can be measured. However, during a read operation, there may be a time difference in the on/off timing between the first selection transistor D-TR and the second selection transistor S-TR.

The memory system 100 may apply a predetermined voltage (e.g., +20V) to the substrate through a source line SL during an erasure operation. The memory system 100 may apply a certain voltage to allow both the first selection transistor D-TR and the second selection transistor S-TR to float during an erasure operation. As a result, the applied erasure voltage can remove electrical charges from the floating gates FG of the selected memory cells.

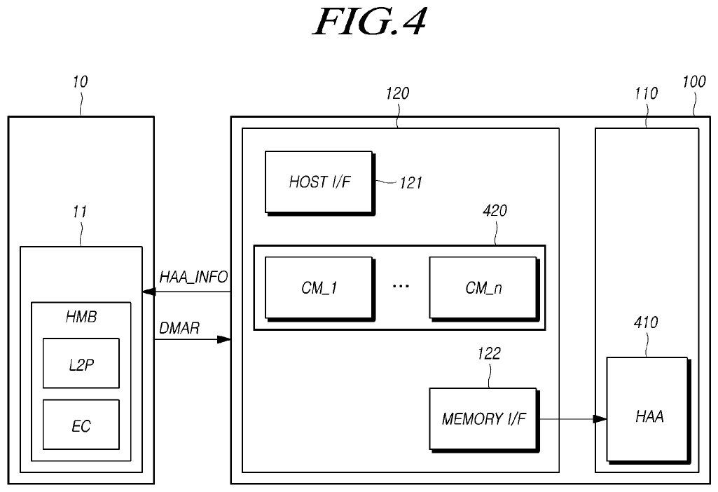

FIG. 4 is a diagram illustrating an external device and a memory system according to embodiments of the present disclosure.

Referring to FIG. 4, a memory device 110 of the memory system 100 may include a host accessible area 410.

The host accessible area 410 refers to an area in which a direct memory access DMA may be possible from the outside of the memory system 100.

The direct memory access DMA from the external device 10 to the memory device 110 may mean that a memory controller 120 accesses an address on the memory device 110 indicated by the external device 10 without performing mapping, etc. between a logical address and a physical address.

The memory controller 120 may designate a part of the entire area of the memory device 110 as the host accessible area 410. The memory controller 120 may transmit information on the host accessible area HAA_INFO to an external memory 11 of the memory system 100. Here, the external memory 11 may be memory included in the external device 10, or, contrary to what FIG. 4 shows, the external memory 11 may be located outside the external device 10.

The information on the host accessible area HAA_INFO that has been transmitted to the external memory 11 may be stored in the external memory 11.

The memory controller 120 may write the information on the host accessible area HAA_INFO to a host memory buffer HMB area included in the external memory 11.

The external device 10 may generate a direct memory access request DMAR to access the host accessible area 410 on the basis of the information for the host accessible area HAA_INFO stored in the external memory 11.

The memory controller 120 may receive the direct memory access request DMAR generated based on the information for the host accessible area HAA_INFO from the external device 10.

The memory controller 120 may provide the external device 10 with the direct memory access DMA to access the host accessible area 410 in response to the direct memory access request DMAR.

Referring to FIG. 4, the memory controller 120 may include a plurality of control modules 420 that receive power to perform the operation.

The control module CM is a unit corresponding to various modules or cores included in the memory controller 120.

For example, as described above, the memory controller 120 may include a processor 124 that may include a plurality of cores. Here, since one core corresponds to one control module CM, it can be seen that the memory processor 124 includes the plurality of control modules.

A host interface layer HIL, a flash translation layer FTL, and a flash interface layer FIL that are layers of firmware of the memory controller 120 may respectively process a command or data received from the external device 10 through one or more related control modules CM.

One control module CM may be associated with one or more layers of the firmware.

The memory controller 120 may include various types of control modules CM such as a command management module performing command fetching and parsing, etc., a module to manage command metadata, an ECC module to detect and correct an error in data received from a host, or a host data transfer module. The present disclosure is not limited to the above-mentioned control modules CM, and the memory controller 120 may include control modules CM of various functions.

Referring to FIG. 4, the information on the host accessible area HAA_INFO may include a logical to physical (L2P) table L2P for the host accessible area 410 and an erase count EC of a memory block included in the host accessible area 410.

The external device 10 may generate the direct memory access request DMAR based on the L2P table L2P and the erase count EC of the memory block included in the host accessible area 410.

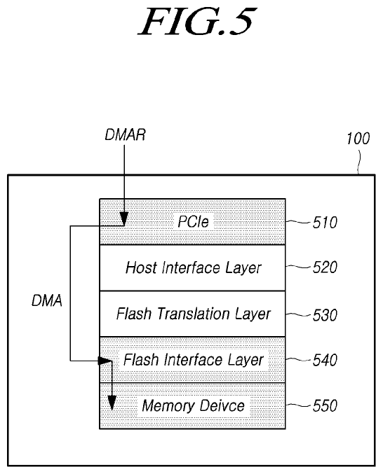

FIG. 5 is a diagram illustrating a memory access path of the external device by layer according to embodiments of the present disclosure.

Referring to FIGS. 4 and 5, the external device 10 may access the host accessible area 410 included in the memory device 110.

When the external device 10 transmits a reading or writing command to the memory system 100 in a general method, a PCIe layer 510 of the memory controller 120 may receive a command from the external device 10. The PCIe layer 510 may transmit the command to a host interface layer 520. The host interface layer 520 may transmit the command to a flash translation layer 530. The flash translation layer 530 may transmit the command to a flash interface layer 540. The flash interface layer 540 may transmit the command indicated by the flash translation layer 530 to the memory device 110.

When the external device 10 has transmitted the direct memory access request DMAR to the memory system 100, the PCIe layer 510 of the memory controller 120 may transfer the direct memory access request DMAR to the flash interface layer 540 without going through the host interface layer 520 and the flash translation layer 530. The flash interface layer 540 may receive the direct memory access request DMAR from the PCIe layer 510 and transmit the reading or writing command to the memory device 550. The memory device 550 may read or write data to the host accessible area according to a command received from a memory interface layer.

The PCIe layer 510 is an example to describe a layer for communication with the external device 10, and may be a layer that provides an interface with the external device 10 as well as PCI express, which is a communication standard.

Some or all of the plurality of control modules 420 included in the memory controller 120 may be used to process the command received from the external device 10. Here, some or all of the plurality of control modules 420 may correspond to one or more firmware layers among the host interface layer HIL, the flash translation layer FTL, and the flash interface layer FIL.

When the memory controller 120 processes the direct memory access request DMAR, it may transmit the command to the flash interface layer FIL, bypassing some or all of the control modules corresponding to the host interface layer HIL and the flash translation layer FTL.

As a result, the external device 10 may read data from the host accessible area 410 without performing mapping between the logical and physical addresses of the memory controller 120, or may write the data to the host accessible area 410.

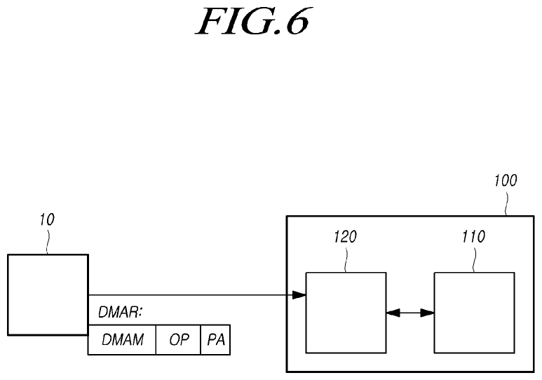

FIG. 6 is a diagram illustrating a direct memory access request according to embodiments of the present disclosure.

Referring to FIG. 6, the direct memory access request DMAR may include at least one of information for a direct memory access mode DMAM, an operation code OP, and a physical address PA to which an external device is to access.

When the information for the direct memory access mode DMAM is set, a memory controller 120 may provide the external device with access to a host accessible area 410.

The operation code OP is a code instructing an operation to be performed by a memory device 110. The memory controller 120 may perform an operation corresponding to the operation code OP to the physical address PA to which the external device is to access.

The physical address PA is an address on the host accessible area 410 included in the memory device 110 to which the external device 10 is to read or write data.

When not in the case of a direct memory access DMA, after a logical address received from the external device 10 is translated into the physical address based on a mapping table in a flash translation layer FTL, it may be possible that the external device 10 accesses corresponding data when accessing the memory device 110.

When the external device 10 accesses the host accessible area 410 by the direct memory access DMA, it transmits the direct memory access request DMAR including the physical address PA to be accessed to the memory controller 120. As a result, no translation from the logical address to the physical address is required.

Furthermore, the direct memory access request DMAR may be generated according to an urgent event including a sudden power-off or a thermal warning.

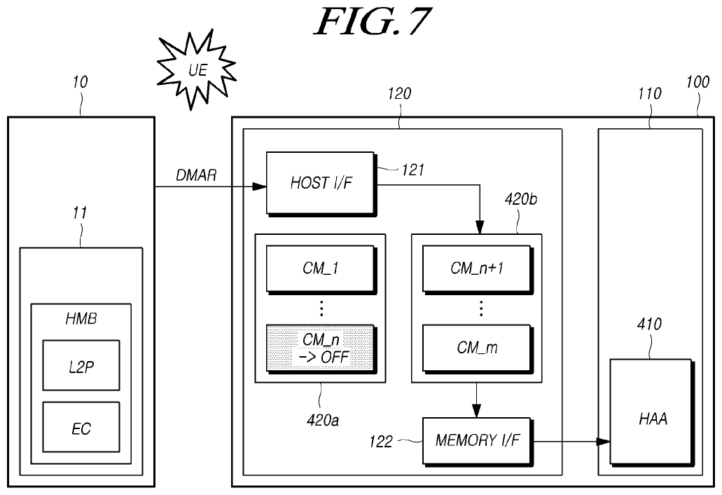

FIG. 7 is a diagram illustrating an operation of a memory controller in response to an urgent event according to embodiments of the present disclosure.

An external device 10 may transmit a direct memory access request DMAR to the memory controller 120 in response to the urgent event UE.

In response to the urgent event UE, the memory controller 120 may stop processing a command being processed and process the direct memory access request DMAR received from the external device 10.

In general, when the urgent event UE occurs, the memory controller 120 may finish processing of an unprocessed command instead of fetching a new command.

In the meantime, when the external device 10 accesses a host accessible area 410 by the direct memory access request DMAR according to the urgent event UE, the memory controller 120 may stop processing a command being processed in response to the urgent event UE and process the direct memory access request DMAR received from the external device 10.

In this case, the direct memory access request DMAR may include data that the external device 10 must store in a memory device 110 or must read in preparation for the urgent event UE.

In response to the urgent event UE, the memory controller 120 may cut off power of one or more control modules unrelated to the direct memory access request DMAR among a plurality of control modules included in the memory controller 120.

As described above, when the external device 10 accesses the host accessible area 410 by a direct memory access DMA, some of the plurality of control modules 420 included in the memory controller 120 may be bypassed. Here, the memory controller 120 may cut off power of the bypassed control modules.

As shown in FIG. 7, the plurality of control modules 420a may not be related to the direct memory access DMA. Accordingly, the memory controller 120 may cut off the power to one or more control modules CM_n among the plurality of control modules 420a.

The memory controller 120 may lower power consumption by cutting off the power to one or more control modules, so that it is possible to secure sufficient time to respond to the urgent event UE, lower temperature, etc.

For an example, when the urgent event UE is a sudden power-off, it may be possible to secure time to respond to the sudden power-off by reducing power consumption. In addition, when the urgent event UE is a thermal warning, it may be possible to lower temperature of a memory system by reducing power consumption.

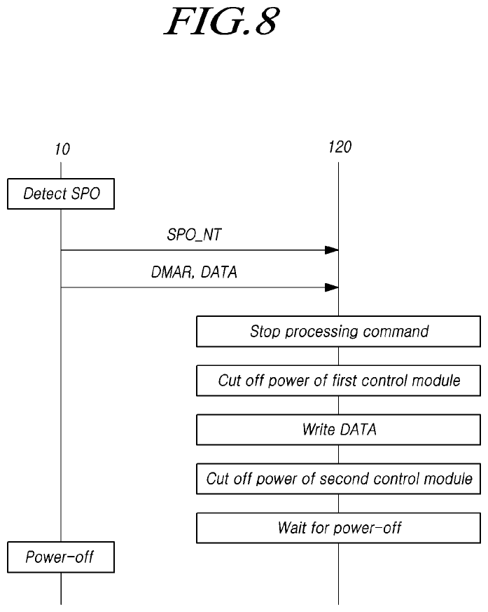

FIG. 8 is a diagram illustrating an operation of a memory controller during a sudden power-off according to embodiments of the present disclosure.

Referring to FIG. 8, the memory controller 120 may be capable of coping with the sudden power-off SPO.

An external device 10 may transmit a sudden power-off notification signal SPO_NT to the memory controller 120 when detecting the sudden power-off SPO generated in the external device 10. Furthermore, the memory controller 120 may detect the sudden power-off SPO generated in a memory system 100 and report it to the external device 10. Hereinafter, the operation of the memory controller 120 will be described based on the sudden power-off SPO being generated in the external device 10.

The external device 10 may generate a direct memory access request DMAR based on information for a host accessible area HAA_INFO in response to the sudden power-off SPO, which is an urgent event.

The memory controller 120 may receive the direct memory access request DMAR from the external device 10 and then provide a direct memory access DMA to access the host accessible area 410 to the external device 10.

Here, the memory controller 120 may stop processing a command being processed.

In addition, the memory controller 120 may cut off power supplied to one or more control modules unrelated to the direct memory access request DMAR among a plurality of control modules included in the memory controller 120.

For example, during the direct memory access DMA, the memory controller 120 may cut off power supplied to a control module related to a host interface layer HIL and a flash translation layer FTL but not related to a flash interface layer FIL.

When the sudden power-off SPO occurs, the memory controller 120 may receive power from an auxiliary power supply (not shown). In this case, a high-capacity capacitor may provide auxiliary power. Moreover, the time during which the memory system 100 is driven by the auxiliary power supply is relatively short.

Since the memory controller 120 may cut off the power supplied to one or more control modules to reduce power consumption and increase the time to perform a sudden power-off protection, it may be capable of effectively responding to the sudden power-off SPO.

The memory controller 120 may write data DATA received from the external device 10 to the host accessible area 410 included in a memory device 110 by the direct memory access DMA.

In this case, the data DATA written to the host accessible area 410 by the direct memory access DMA may include data that needs to be preserved in preparation for the sudden power-off SPO in the external device 10. For example, it may be data required for recovery of the external device 10.

Furthermore, the data DATA written to the host accessible area 410 by the direct memory access DMA may include backup data for recovery of the information for the host accessible area.

When the sudden power-off SPO occurs in the external device 10, information stored in an external memory 11 may be lost. The backup data for recovery of the information for the host accessible area is for recovering the information on the host accessible area when data stored in the external memory 11 has been lost due to the sudden power-off SPO.

Further, the memory controller 120 may cut off power supplied to one or more control modules related to the processing of the direct memory access request DMAR among the plurality of control modules included in the memory controller 120 after processing the direct memory access request DMAR.

Thereafter, the memory controller 120 may be waiting for power-off due to the sudden power-off SPO.

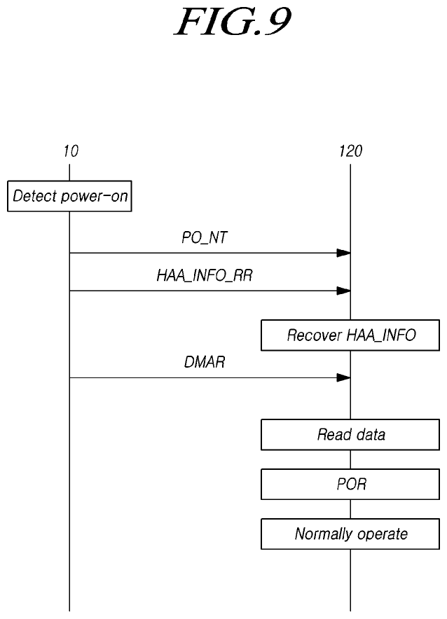

FIG. 9 is a diagram illustrating an operation of a memory controller during a power-on recovery according to embodiments of the present disclosure.

Referring to FIG. 9, after an urgent event is resolved, the memory controller 120 may receive a recovery request HAA_INFO_RR for information for a host accessible area from an external device 10 in response to the power-on recovery. The memory controller 120 may transmit backup data to the external device 10 in response to the recovery request HAA_INFO_RR for the information for the host accessible area.

When power-on is detected, the external device 10 may transmit a power-on notification signal PO_NT and the recovery request HAA_INFO_RR for the information for the host accessible area to the memory controller 120.

The memory controller 120 may transmit backup data for recovery of the information for the host accessible area HAA_INFO to the external device 10, thereby recovering the information for the host accessible area HAA_INFO on an external memory 11.

After the information for the host accessible area HAA_INFO for the external memory 11 is recovered, the external device 10 may read data required for the power-on recovery of the external device 10 by a direct memory access DMA to the host accessible area 410 before the power-on recovery POR of a memory system 100 is completed.

The memory controller 120 may recover a mapping table, etc. during the power-on recovery POR of the memory system 100.

Even when the operation of the power-on recovery POR of the memory system 100 is not completed and, therefore, a reading or writing operation by a logical address and the mapping table is limited, the external device 10 may read data necessary for the power-on recovery of the external device 10 by the direct memory access DMA to the host accessible area 410 in order to utilize it for recovery. The memory controller 120 may operate normally after the power-on recovery POR of the memory system 100 is completed.

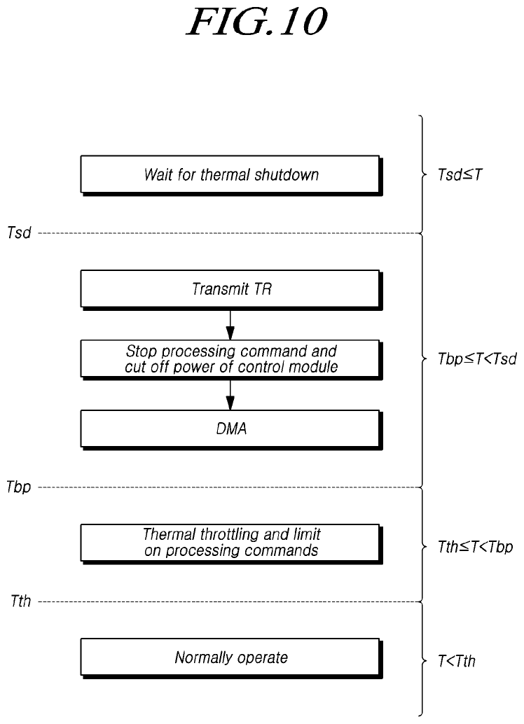

FIG. 10 is a diagram illustrating an operation of a memory controller for each temperature according to embodiments of the present disclosure.

Referring to FIG. 10, the memory controller 120 may be capable of preparing for a thermal shutdown.

The memory controller 120 may periodically measure a reference temperature T. The reference temperature T may be the temperature of the memory controller 120 or a memory device 110. Alternatively, the reference temperature T may be a value obtained by combining temperatures obtained by a plurality of temperature sensors included in the memory controller 120 or the memory device 110.

The memory controller 120 may perform different operations for each reference temperature T. When the reference temperature T is lower than a threshold throttling temperature Tth T<Tth, the memory controller 120 may perform a normal operation. When the memory controller 120 performs the normal operation, it may mean that it operates without limitation due to temperature.

When the reference temperature T is equal to or higher than the threshold throttling temperature Tth and lower than a threshold backup temperature Tbp Tth≤T<Tbp, the memory controller 120 may perform a thermal throttling to limit clocks of one or more control modules 420. In addition, the memory controller 120 may limit the amount of processing commands received from an external device 10. The memory controller 120 may be capable of preventing the memory system 100 from overheating by performing the thermal throttling and limiting the amount of processing the commands.

Even if the memory controller 120 performs the thermal throttling and limits the amount of processing the commands, the reference temperature T may increase due to external factors, etc. When the reference temperature T is equal to or higher than the threshold backup temperature Tbp and is lower than the threshold shutdown temperature Tsd Tbp≤T<Tsd, the memory controller 120 may transmit a thermal warning TR to the external device 10. The external device 10 may prepare for the thermal shutdown of the memory system 100 in response to the thermal warning TR.

After transmitting the thermal warning TR, the memory controller 120 may stop processing a command being processed and may cut off power supplied to one or more control modules CM among a plurality of control modules CM.

In this case, the control modules CM that are powered off may be ones unrelated to a direct memory access DMA to access a host accessible area 410 of the external device 10.

The memory controller 120 may provide the direct memory access DMA to the external device 10 in order to read data DATA stored in the host accessible area 410 or write data DATA to the host accessible area 410.

The data DATA read from the host accessible area 410 by the direct memory access DMA may be data that needs to be read from the external device 10 prior to the thermal shutdown.

The data DATA written to the host accessible area 410 by the direct memory access DMA may include data that needs to be preserved in the external device 10 in case of the thermal shutdown. For example, the data DATA written to the host accessible area 410 may be data required for recovery of the external device 10 or the memory system 100.

When the reference temperature T is equal to or higher than a threshold shutdown temperature Tsd Tsd≤T, the memory controller 120 may stop its operation and wait for the thermal shutdown. Thereafter, the memory system 100 may be powered off due to the thermal shutdown.

After the overheating of the memory system 100 is resolved, the memory controller 120 may perform the operation of the power-on recovery described above with reference to FIG. 9.

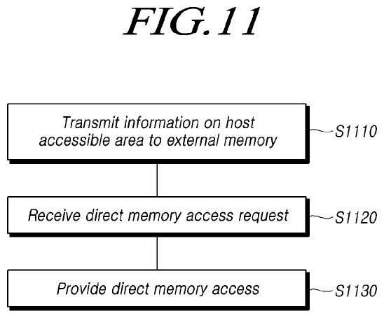

FIG. 11 is a diagram illustrating an operating method of a memory system according to embodiments of the present disclosure.

Referring to FIG. 11, the operating method of the memory system 100 may include the operation (S1100) of transmitting information HAA_INFO on a host accessible area 410 accessible directly from an external device 10 to an external memory 11.

The information HAA_INFO on the host accessible area 410 may include an L2P table L2P for the host accessible area 410 and an erase count EC of a memory block included in the host accessible area 410.

In this case, a direct memory access request DMAR may include at least one of information for a direct memory access mode DMAM, an operation code OP, and a physical address PA to which the external device is to access.

The operating method of the memory system 100 may include the operation (S1120) of receiving the direct memory access request DMAR generated based on the information HAA_INFO on the host accessible area 410 from the external device 10 in response to an urgent event UE including a sudden power-off of the external device 10 or a thermal warning of the memory system 100.

The operating method of the memory system 100 may include the operation (S1130) of providing the external device 10 with the direct memory access DMA to the host accessible area 410 in response to the direct memory access request DMAR.

The operating method of the memory system 100 may include, in response to the memory urgent event UE, the operation of stopping processing of a command being processed and the operation of processing the direct memory access request DMAR.

The operating method of the memory system 100 may include the operation of cutting off, in response to the urgent event UE, power supplied to one or more control modules unrelated to the direct memory access request among a plurality of control modules that receive power to perform the operation.

The operating method of the memory system 100 may include the operation of cutting off, when the urgent event UE is the sudden power-off, power supplied to one or more control modules related to the processing of the direct memory access request among the plurality of control modules after processing the direct memory access request.

The operating method of the memory system 100 may include the operation of transmitting the thermal warning to the external device 10 when a reference temperature of the memory system 100 is equal to or higher than a threshold backup temperature to prepare for a thermal shutdown of the memory system 100.

The direct memory access request DMAR may include a request to write backup data for recovery of the information HAA_INFO on the host accessible area 410 included in the external memory 11.

The operating method of the memory system 100 may include the operation of receiving a request to recover the information HAA_INFO on the host accessible area 410 from the external device 10 in response to power-on.

The operating method of the memory system 100 may include the operation of receiving, after the urgent event UE is resolved, the request to recover the information HAA_INFO for the host accessible area 410 from the external device 10 in response to the power-on.

The operating method of the memory system 100 may include the operation of transmitting backup data to the external device 10 in response to the request to recover the information HAA_INFO for the host accessible area 410.

The external device 10 described above may be of various types. For example, the external device 10 may be a host, and the external memory 11 may be a host memory.

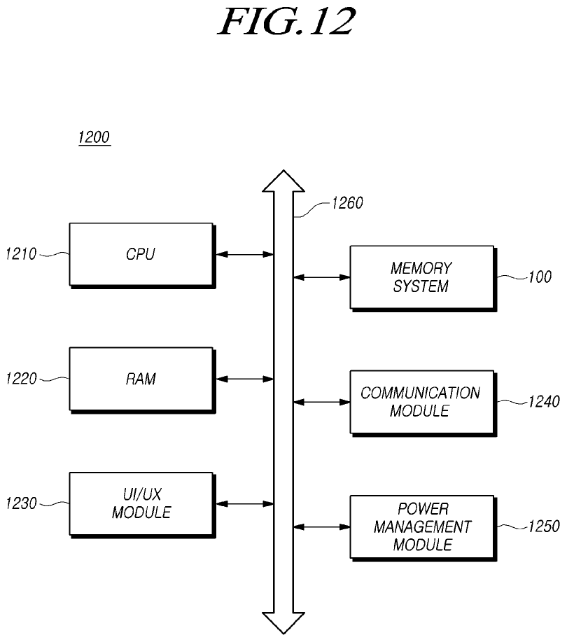

FIG. 12 is a diagram illustrating the configuration of a computing system 1200 based on an embodiment of the present disclosure.

Referring to FIG. 12, the computing system 1200 based on an embodiment of the present disclosure may include: a memory system 100 electrically connected to a system bus 1260; a CPU 1210 configured to control the overall operation of the computing system 1200; a RAM 1220 configured to store data and information related to operations of the computing system 1200; a user interface/user experience (UI/UX) module 1230 configured to provide the user with a user environment; a communication module 1240 configured to communicate with an external device as a wired and/or wireless type; and a power management module 1250 configured to manage power used by the computing system 1200.

The computing system 1200 may be a personal computer (PC) or may include a mobile terminal such as a smartphone, a tablet or various electronic devices.

The computing system 1200 may further include a battery for supplying an operating voltage, and may further include an application chipset, a graphic-related module, a camera image processor, and a DRAM. Other elements would be apparent to a person skilled in the art.

The memory system 100 may include not only a device configured to store data in a magnetic disk such as a hard disk drive (HDD), but also a device configured to store data in a nonvolatile memory such as a solid state drive (SSD), a universal flash storage device, or an embedded MMC (eMMC) device. The non-volatile memory may include a read only memory (ROM), a programmable ROM (PROM), an electrically programmable ROM (EPROM), an electrically erasable and programmable ROM (EEPROM), a flash memory, a phase-change RAM (PRAM), a magnetic RAM (MRAM), a resistive RAM (RRAM), a ferroelectric RAM (FRAM), and the like. In addition, the memory system 100 may be implemented as storage devices of various types and mounted inside various electronic devices.

Based on embodiments of the present disclosure described above, the operation delay time of the memory system may be advantageously reduced or minimized. In addition, based on an embodiment of the present disclosure, an overhead occurring in the process of calling a specific function may be advantageously reduced or minimized. Although various embodiments of the present disclosure have been described with particular specifics and varying details for illustrative purposes, those skilled in the art will appreciate that various modifications, additions and substitutions may be made based on what is disclosed or illustrated in the present disclosure and the following claims. Furthermore, the embodiments may be combined to form additional embodiments.

What is claimed is:

1. A memory system comprising:
a memory device comprising a host accessible area accessible by an external device; and
a memory controller suitable for transmitting, to an external memory, information on the host accessible area, receiving, from the external device in response to an urgent event, a direct memory access request generated based on the information on the host accessible area, and providing, in response to the direct memory access request, the external device with access to the host accessible area.

2. The memory system of claim 1, wherein the urgent event is a sudden power-off of the external device or a thermal warning of the memory system.

3. The memory system of claim 1, wherein the information for the host accessible area comprises a logical to physical (L2P) table for the host accessible area and an erase count of a memory block in the host accessible area.

4. The memory system of claim 1, wherein the direct memory access request comprises at least one of information for a direct memory access mode, an operation code, and a physical address to which the external device is to access.

5. The memory system of claim 1, wherein the memory controller is further suitable for, in response to the urgent event:
stopping processing of a command being processed, and
processing the direct memory access request.

6. The memory system of claim 2,
wherein the memory controller comprises a plurality of control modules receiving power to perform the operation, and
wherein the memory controller is further suitable for cutting off, in response to the urgent event, power supplied to one or more control modules unrelated to the direct memory access request among the plurality of control modules.

7. The memory system of claim 6, wherein the memory controller is further suitable for cutting off, after processing the direct memory access request, power supplied to one or more control modules related to the processing of the direct memory access request among the plurality of control modules when the urgent event is the sudden power-off.

8. The memory system of claim 6, wherein the memory controller is further suitable for transmitting the thermal warning to the external device when a reference temperature of the memory system is equal to or higher than a threshold backup temperature in preparation for a thermal shutdown of the memory system.

9. The memory system of claim 2, wherein the direct memory access request is a request to write backup data for recovery of the information for the host accessible area stored in the external memory.

10. The memory system of claim 9, wherein the memory controller is further suitable for:
receiving, from the external device after the urgent event is resolved, a request to recover the information on the host accessible area in response to power-on, and
transmitting the backup data to the external device in response to the request to recover the information.

11. An operating method of a memory system, the operating method comprising:
transmitting, to an external memory, information for a host accessible area accessible by an external device;
receiving, from the external device in response to an urgent event, a direct memory access request generated based on the information for the host accessible area; and
providing, in response to the direct memory access request, the external device with access to the host accessible area.

12. The operating method of claim 11, wherein the urgent event is a sudden power-off of the external device or a thermal warning of the memory system.

13. The operating method of claim 11, wherein the information for the host accessible area comprises an L2P table for the host accessible area and an erase count of a memory block in the host accessible area.

14. The operating method of claim 11, wherein the direct memory access request comprises at least one of information for a direct memory access mode, an operation code, and a physical address to which the external device is to access.

15. The operating method of claim 11, further comprising, in response to the urgent event:
stopping processing of a command being processed; and
processing the direct memory access request.

16. The operating method of claim 12, further comprising cutting off, in response to the urgent event, power supplied to one or more control modules unrelated to the direct memory access request among a plurality of control modules that receive power to perform the operation.

17. The operating method of claim 16, further comprising cutting off, after processing the direct memory access request, power supplied to one or more control modules related to the processing of the direct memory access request among the plurality of control modules when the urgent event is the sudden power-off.

18. The operating method of claim 16, further comprising transmitting the thermal warning to the external device when a reference temperature of the memory system is equal to or higher than a threshold backup temperature to prepare for a thermal shutdown of the memory system.

19. The operating method of claim 12, wherein the direct memory access request is a request to write backup data for recovery of the information on the host accessible area stored in the external memory.

20. The operating method of claim 19, further comprising:
receiving, from the external device after the urgent event is resolved, a request to recover the information on the host accessible area in response to power-on; and
transmitting the backup data to the external device in response to the request to recover the information.

21. An operating method of a controller, the operating method comprising:
providing an external device with information representing a relationship between logical and physical addresses related to a memory block within a memory device; and
allowing, in response to a request from the external device, the external device to directly control the memory device to perform an operation to access the memory block according to the physical address,
wherein the request includes the physical address and a direction for the operation.

22. The operating method of claim 21,
further comprising powering off, during the allowing, one or more irrelevant elements among elements within the controller while keeping remaining elements powered on,
wherein the irrelevant elements are not related for the external device to directly control the memory device.

23. The method of claim 21, further comprising receiving the request when power supply to the external device is interrupted or a temperature of the memory device becomes greater than a threshold.
